(19) United States
(12) Patent Application Publication
(10) Pub. No.: US 2006/0282357 A1
(43) Pub. Date: Dec. 14, 2006

(54) Selecting a building system component

(76) Inventors: Gary D. Southern, Littleton, CO (US); Joshua Z. Southern, Arvada, CO (US)

Correspondence Address: DAHL & OSTERLOTH, L.L.P., 555 SEVENTEENTH STREET, SUITE 3405, DENVER, CO, 80202-3937, US

(21) Appl. No.: 11/122,475

(22) Filed: May 5, 2005

(51) Int. Cl. G06Q 40/00

(52) U.S. Cl. 705/35; 705/28

(57) ABSTRACT

A method of the present invention for selecting a building system component includes compiling information about a building system component; compiling information about a customer; generating without additional user input a menu of building system component options available to the customer, the menu being based on at least the information about the building system component and the customer; presenting the menu to the customer; and having the customer select a building system component from among the building system component options on the menu.

### TECHNICAL FIELD

This invention relates generally to a method and system for selecting a building system component, and more specifically, to a method and system for selecting a building system component from a menu generated without additional user input based on information about a builder, a customer and a building system component.

### BACKGROUND

It used to be that most components in a new home were standard, leaving the home buyer with little in the way of options, except for paint and carpet color. With the explosion in the home building industry and home buyers' desire for numerous upgrades, home buyers must choose dozens of components for their new home under construction, often with limited time and information.

There seems to be little in the way of centralized information easily accessible to each home buyer, or customer, regarding the options and upgrades available for the specific home model that they have selected. Information about options and upgrades may be accessible to the home builder, but not the customer. Where information is available to the customer, it is generally limited to the products of a single manufacturer. For instance, it is known that one heating system manufacturer makes information concerning its products available on the internet. However, this method offers little help to customers because it does not allow for choices from different manufacturers.

Thus, there developed a need to inform customers building a home about the building system component options available to them from a variety of manufacturers based on the builder of the home and the floor plan selected; to keep in contact with the customer throughout the building process and after closing regarding the proper operation and maintenance of the various building system components selected; and to remind the customer of the need to perform required or suggested maintenance.

### SUMMARY

The following summary is provided as a brief overview of the claimed method and system. It shall not limit the invention in any respect, with a detailed and fully enabling disclosure being set forth in the Detailed Description of Embodiments section. Likewise, the invention shall not be restricted in any operational modes or other variables unless otherwise stated herein.

One embodiment of the present invention may comprise a method for selecting a building system component, comprising compiling information about at least one building system component; compiling information about at least one customer; generating without additional user input a menu of building system component options available to said customer, said menu being based on at least said information about said building system component and said information about said at least one customer; presenting said menu to said customer; and having said customer select a building system component from among said building system component options on said menu, said selection comprising a building system component selection.

Another embodiment of the present invention may comprise a system for selecting a building system component, comprising a means for compiling information about at least one building system component; a means for compiling information about at least one customer; a means for generating without additional user input a menu of building system component options available to said customer, said menu being based on at least said information about said at least one building system component and said information about said at least one customer; a means for presenting said menu to said customer; and a means for having said customer select at least one building system component from among said building system component options on said menu, said selection comprising a building system component selection.

### BRIEF DESCRIPTION OF THE FIGURES

The accompanying figures, which are incorporated herein and form a part of the specification, illustrate various embodiments of the present invention and together with the description, serve to explain the invention. In the figures:

FIG. 1 illustrates a method for selecting a building system component.

FIG. 2 illustrates a computer screen that can be used for inputting information about the building system component.

FIG. 3 illustrates information that may be input about the building system component.

FIG. 4 illustrates a computer screen that can be used for inputting information about cost, price or profit margin.

FIG. 5 illustrates calculating a retail price for the building system component.

FIG. 6 illustrates a menu that can be generated without additional user input using the method of the preferred embodiment.

FIG. 7 illustrates the order form that can be generated without additional user input using the preferred embodiment of the present invention.

FIG. 8 illustrates a computer screen that can be used for generating a menu and order form of building system component options without additional user input.

FIG. 9 illustrates a computer screen for printing the menu, printing the order form or downloading or viewing a presentation.

FIG. 10 illustrates a report for tracking presentation of the menu, the order form, the presentation or the on-line store to customers.

### DETAILED DESCRIPTION OF EMBODIMENTS

The present invention comprises a method and system for selecting a building system component. A “building system component” generally includes but is not limited to one or more of the following systems installed or to be installed in a building: plumbing; heating, ventilation and air conditioning (HVAC); lighting; floor covering; window; door; hardware; trim; wall covering and paint; window treatment; entertainment; security; home management (control of lighting, HVAC, security, entertainment and other building systems); kitchen; bathroom; structured wiring; central vacuum; and any other system installed in a building. The building system component may comprise standard equipment offered by a builder as part of the base price of the building, or an enhancement. An “enhancement” includes an addition or upgrade to the standard equipment, typically for an additional price over the base price of the building. “Installer” means anyone installing building system components. The builder may or may not also be the installer. “Building type” means a type of building offered to or occupied by a customer, including but not limited to residential homes, residential and office condominiums, and commercial buildings, and may be described in terms of model, floor plan, size, or other applicable criteria. “Customer” generally includes but is not limited to a home buyer, a commercial tenant, a commercial building purchaser or a buyer of the building system component for an existing building. “On-line store” means an on-line catalogue of parts, add-ons, services, enhancements and any other item regarding the building system component offered for sale to the customer. It may comprise one or more databases and may be accessed at any time, whether before, during or after installation of the building system component. “Retail price” means the price charged to the customer for a building system component selection.

As can be seen from the description of the embodiments below, examples of the problems solved by the present invention are: (1) the customer who may lack adequate information about the building system component options available for the building the customer is purchasing; (2) the installer who does not receive prompt or accurate information about the customer's building system component selection; and (3) the installer and the customer who lose contact with each other after the purchase process. Thus, the present invention improves upon both the ease with which the customer can access building system component information and the quality of the information the customer receives. The method of the present invention also allows the customer to calculate in advance how the customer's total mortgage amount and monthly payment may change as a function of the building system component selection. In addition, the method of the present invention provides a means for communicating the customer's building system component selection directly to the installer so the installer receives accurate information about the customer's building component selection and the timetable for installation. This may help to keep the building construction on schedule. Finally, the present invention facilitates contact between the customer and the installer after the building system component is installed and the building has been completed. This contact enables the installer to instruct the customer about the proper operation and maintenance of the building system component selected. In addition, the method of the present invention may be used to remind the customer about maintenance for the building system component selected and to provide a means for the customer to directly order any parts needed for the building system component directly from the installer or a vendor working with the installer. The foregoing are examples only and are not to be meant to limit the scope of the present invention.

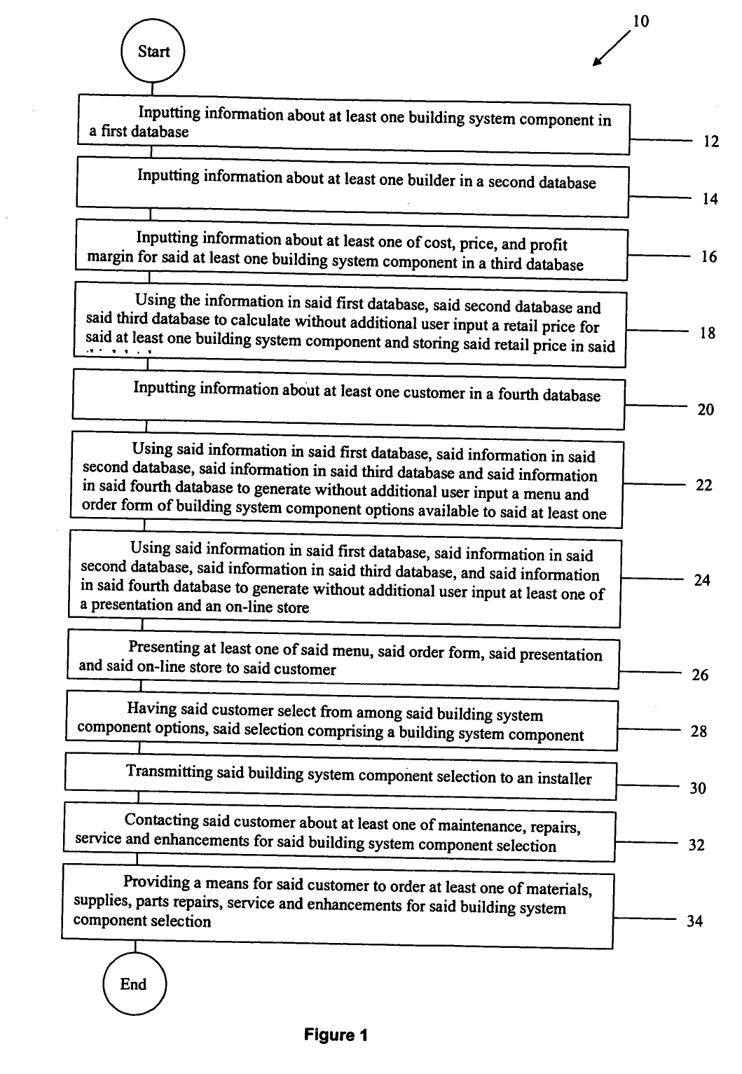

In a preferred embodiment of the invention as shown in FIG. 1, a method 10 for using a computer to select the building system component comprises inputting 12 information about at least one builder in a first database. The information about the builder may include the name of the builder, at least one building type, at least one building system component the builder offers for the building type, and any other information desired. The information about the builder may be input initially and later edited by adding or deleting builders and changing the content of the information for any builder whose information has already been input.

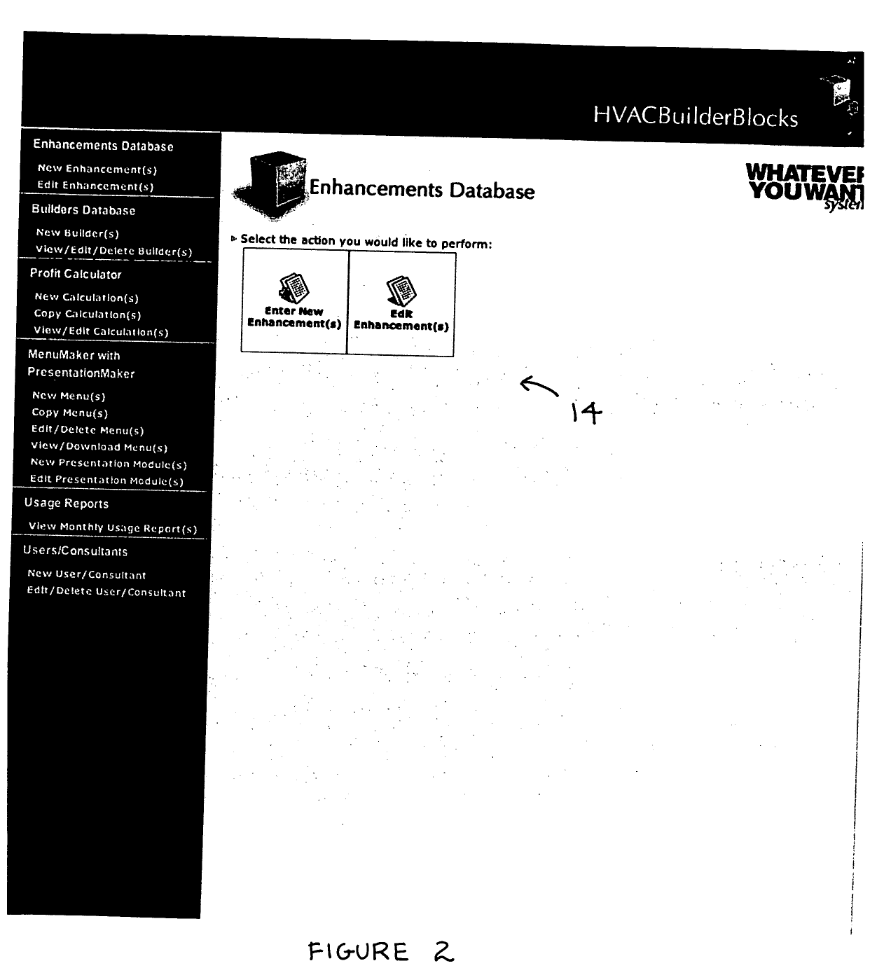

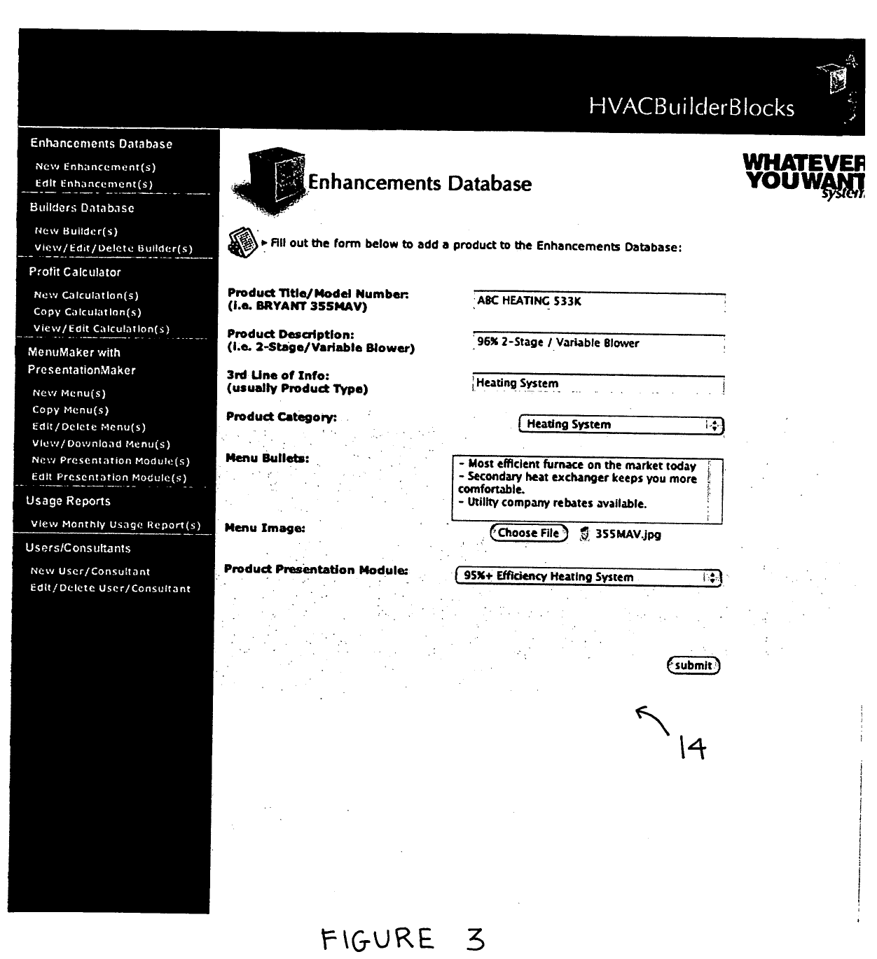

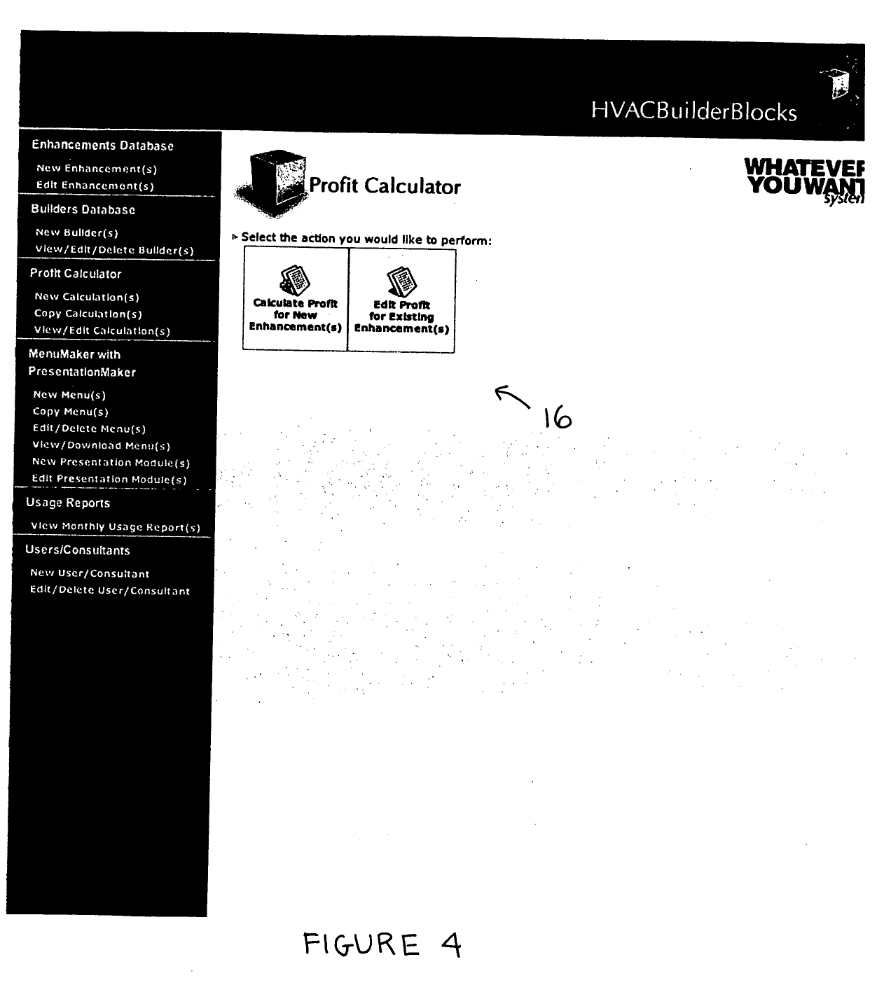

As shown in FIG. 1, the method 10 further comprises inputting 14 information about at least one building system component in a second data base. FIG. 2 shows a computer screen that can be used as part of the preferred embodiment in inputting 14 information about the building system component. As shown on FIG. 2, inputting 14 may comprise editing existing information about the building system component by adding or deleting building system components or changing the content of a description about them. FIG. 3 illustrates the information that may be input about the building system component, such as manufacturer, product, model number, size, capacity or features. Other information about the building system component may comprise a digital or graphic image of each building system component, a digital animation of the building system component's operation and benefits, a description of the building system component as standard equipment or an enhancement, or available rebates.

Returning to FIG. 1, the method 10 further comprises inputting 16 information about at least one of cost, price and profit for the building system component in a third data base. FIG. 4 shows a computer screen that can be used as part of the preferred embodiment for inputting 16 information about cost, price or profit margin for the building system component. As shown in FIG. 4, inputting 16 may comprise editing existing information about cost, price or profit for the building system component.

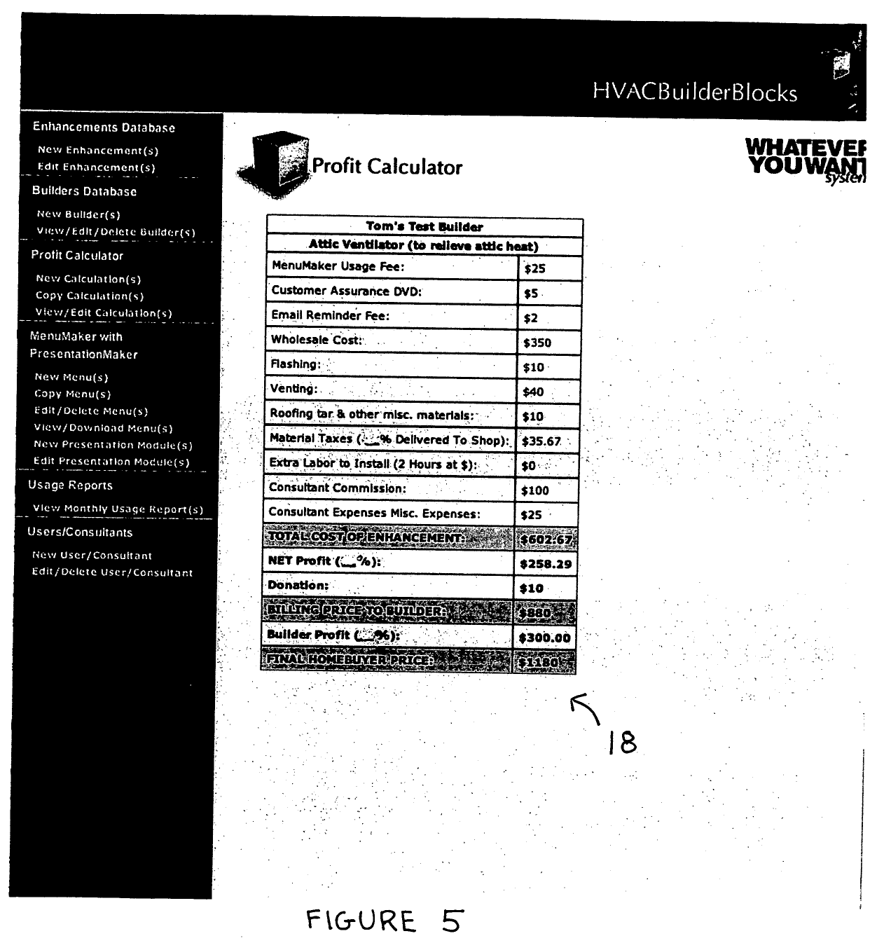

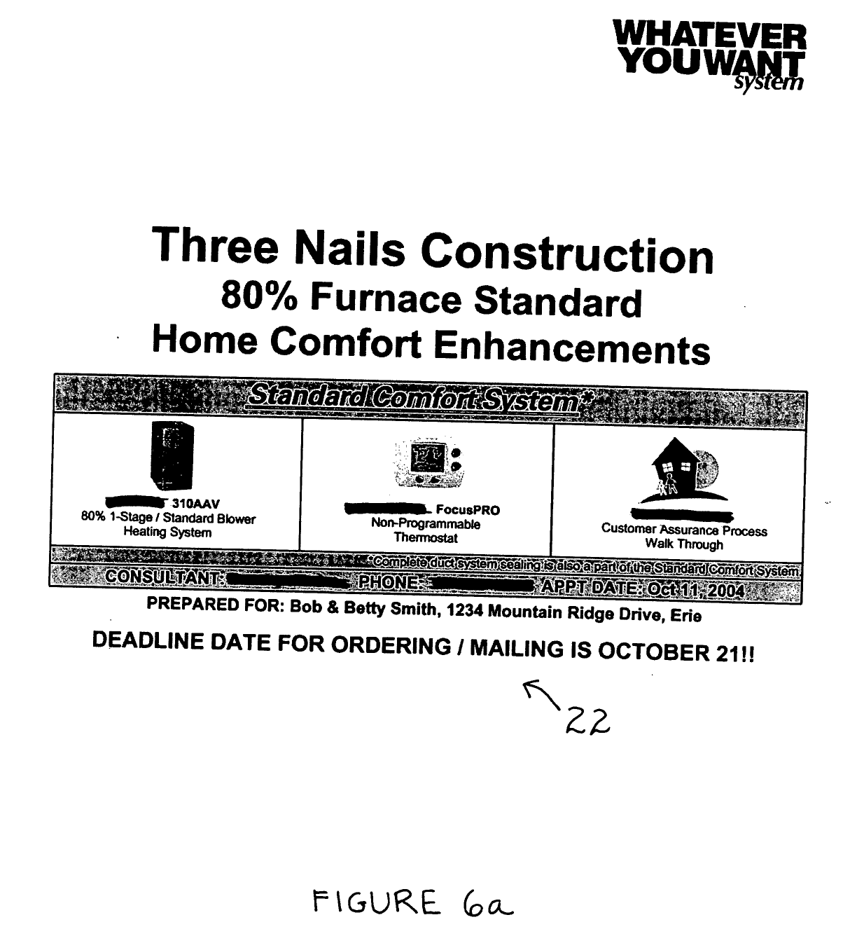

Once the information has been input into the first, second and third databases, the method 10 further comprises using 18 the information in the first database, the second database and the third database to calculate without additional user input a retail price for the building system component. The retail price may be calculated as needed or be stored in the third database. FIG. 5 illustrates calculating a retail price for the building system component.

Returning to FIG. 1, the method 10 further comprises inputting 20 information about at least one customer in a fourth database. The information about the customer may include the customer's name, contact information, the address of the building under construction, the building type of the building under construction, the base price of the building under construction, or mortgage amount and monthly payment. Inputting 20 may comprise editing existing information about the customer throughout the process as more information is developed. For example, once the customer makes a building system component selection (explained below), that information may be added to the fourth database.

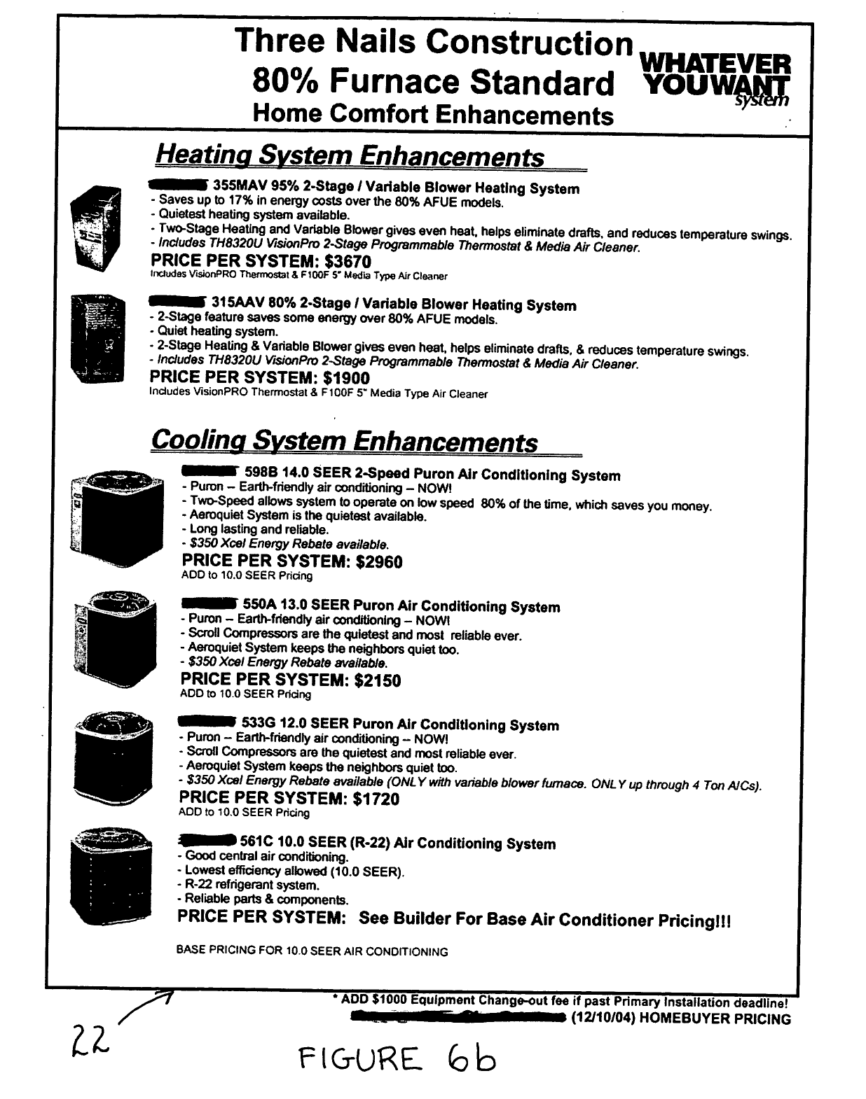

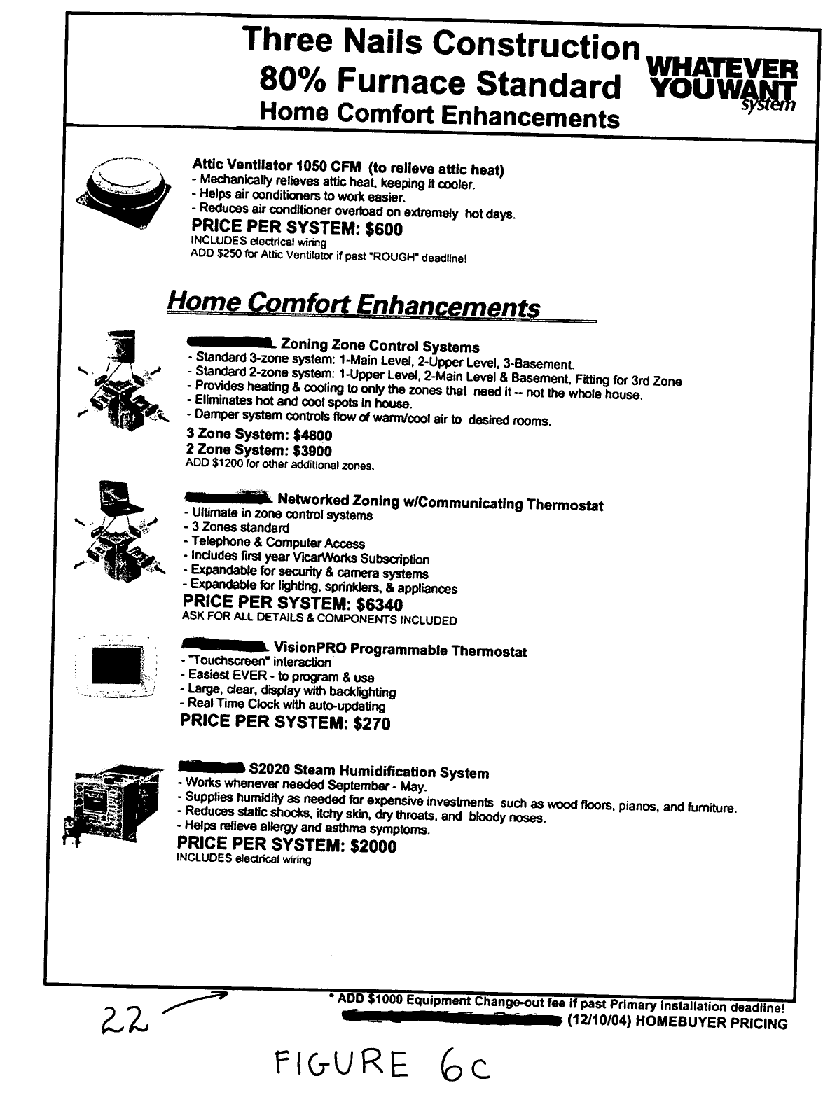

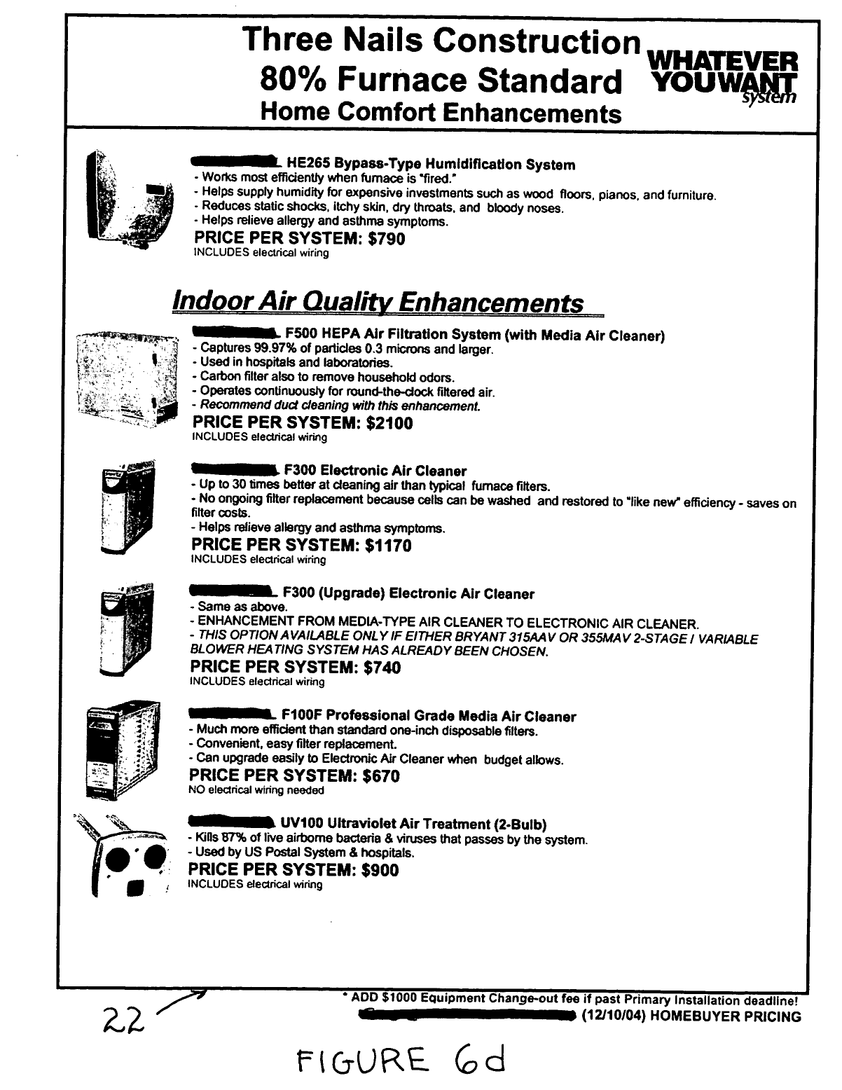

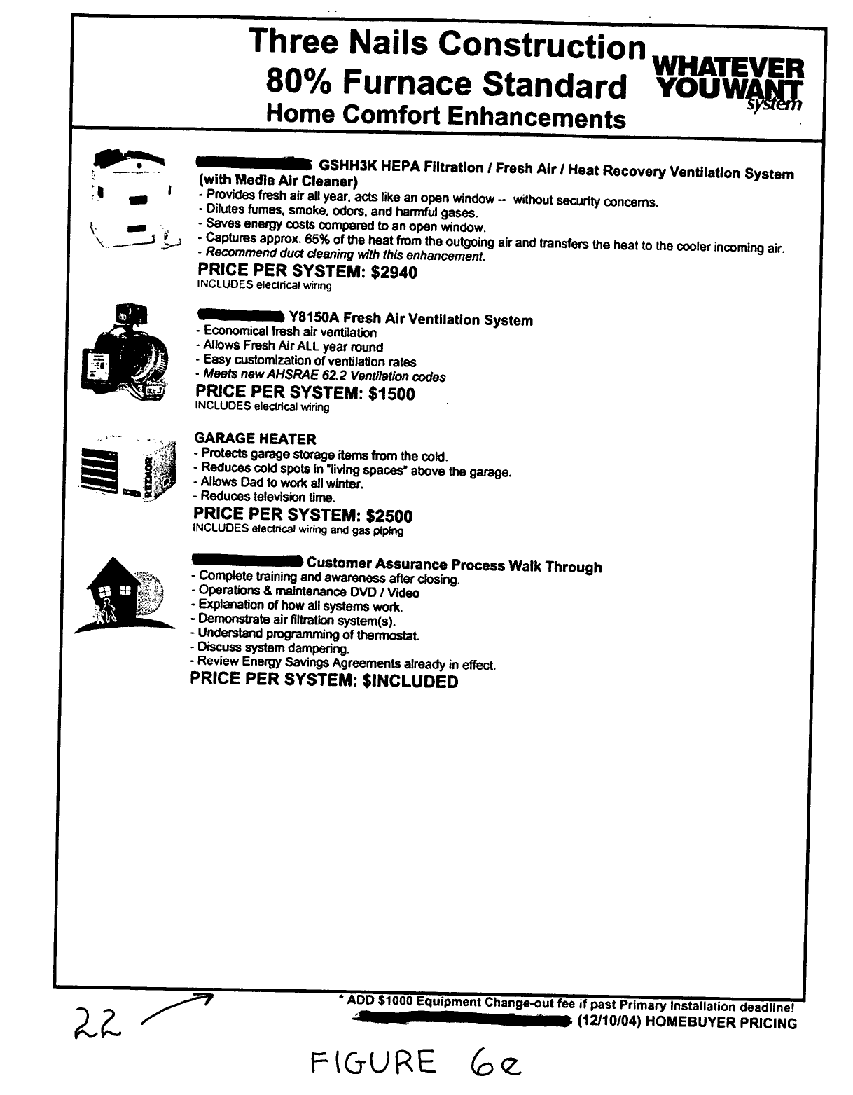

As shown in FIG. 1, the method 10 further comprises using 22 the information in the first, second, third and fourth databases to generate without additional user input a menu and order form of building system component options available to the customer. The building system component options comprise the options from which the customer may make his building system component selection, including, for example, both standard equipment offered by the builder and enhancements available for an additional price. Since the menu may be generated using the information in a number of databases, it may be fairly described as a custom menu for the customer. Generally, the building system component options will be a function of building type. FIG. 6 shows the menu that can be generated without additional user input in the preferred embodiment. The menu may comprise information about each building system component, such as manufacturer, product, model number, size, capacity or features. The menu may also comprise a digital or graphic image of each building system component, a digital animation of the building system component's operation and benefits, a description of the building system component as standard equipment or an enhancement, prices for each enhancement, available rebates or a description of a presentation concerning features of the building system component. The menu may be in written form, electronic form, digital form, or any other available form. In addition, the menu and the order form may be separated into multiple forms or may be combined into a single form.

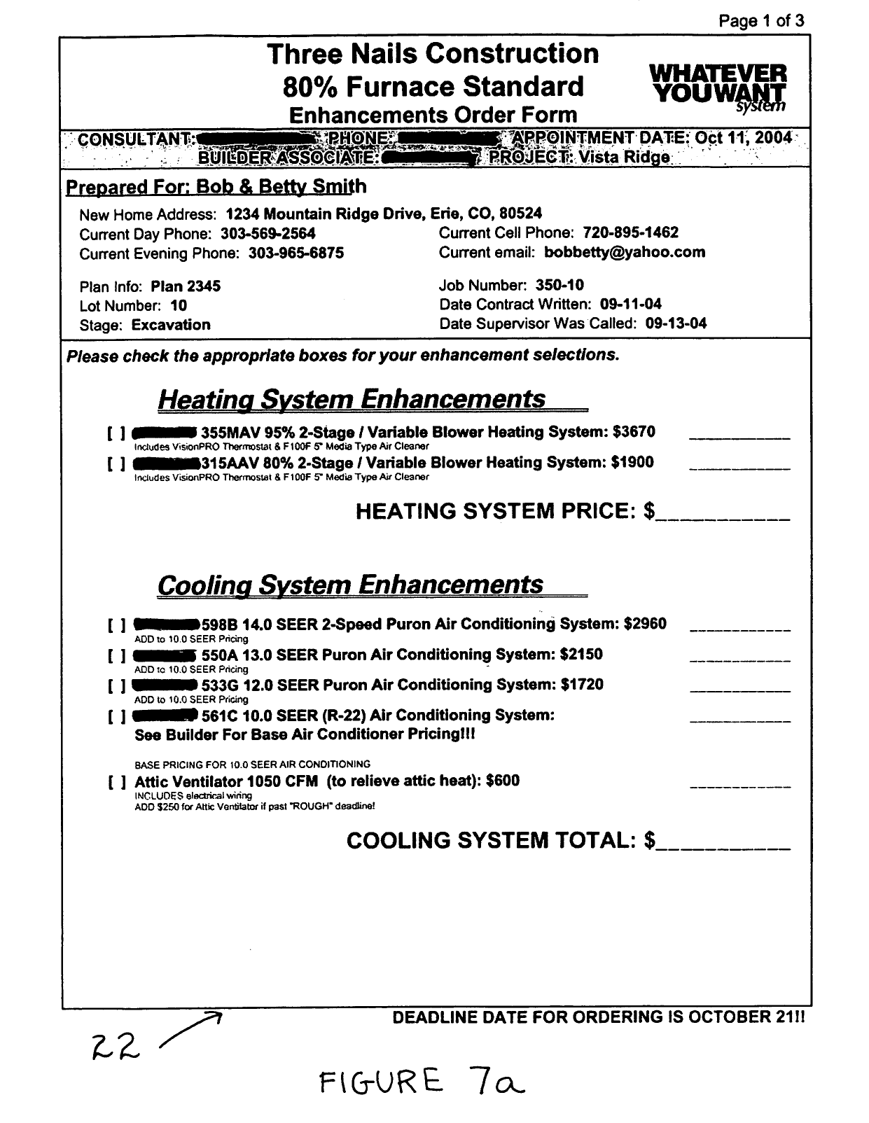

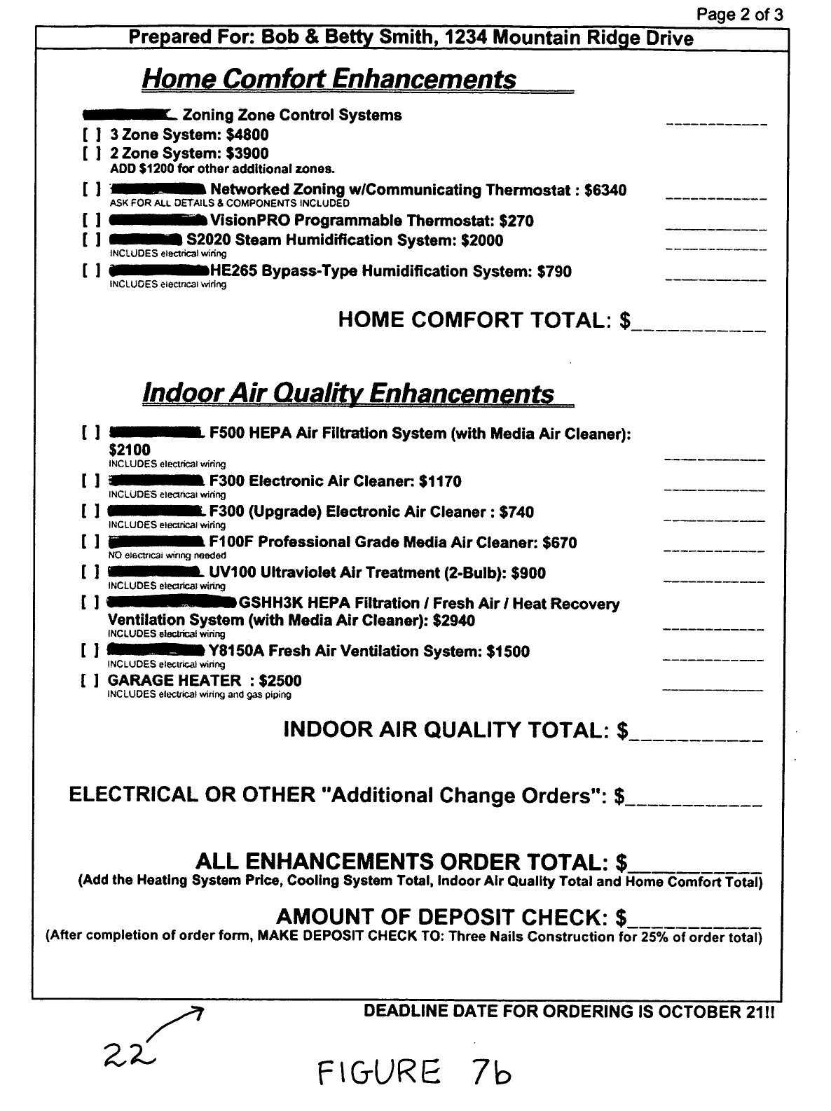

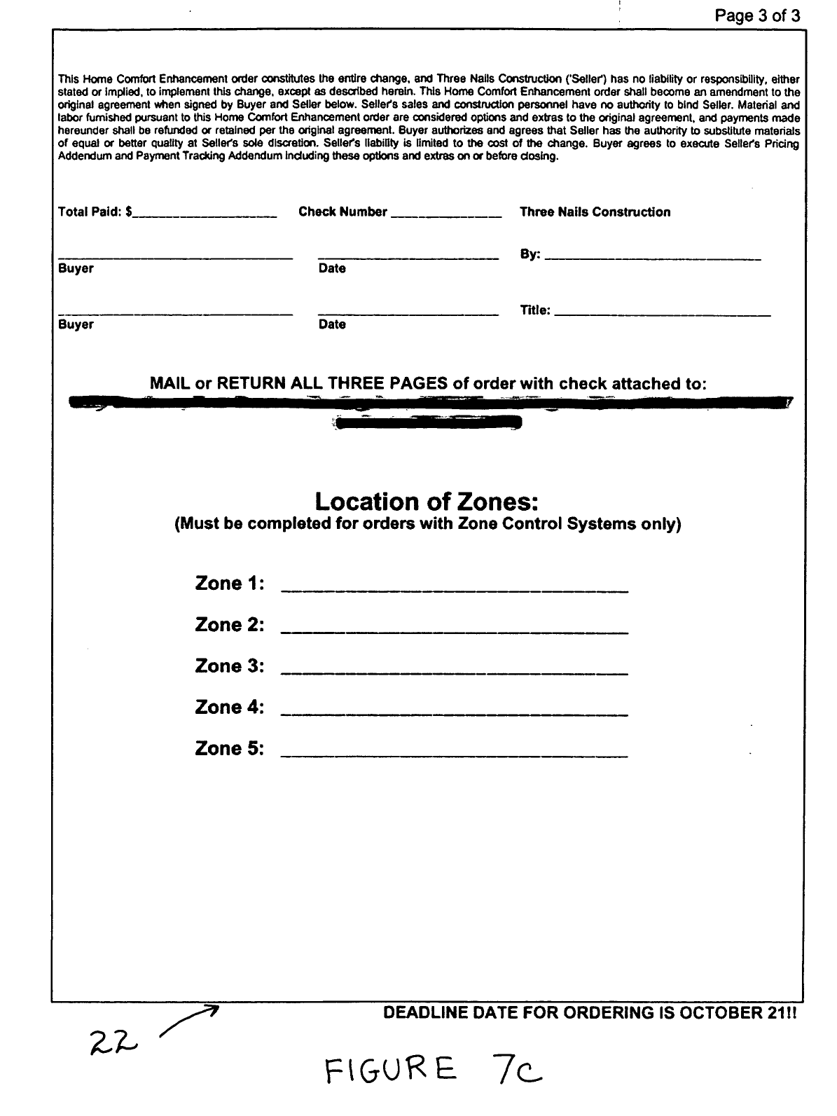

FIG. 7 shows the order form that can be generated using the preferred embodiment of the present invention. The order form may comprise customer information, the building type selected by the customer, a list of building system component options, prices for enhancements, a deadline for ordering, or directions for completing and returning the form to the installer. The order form may also comprise a written contract between the customer and the builder, or the customer and the installer.

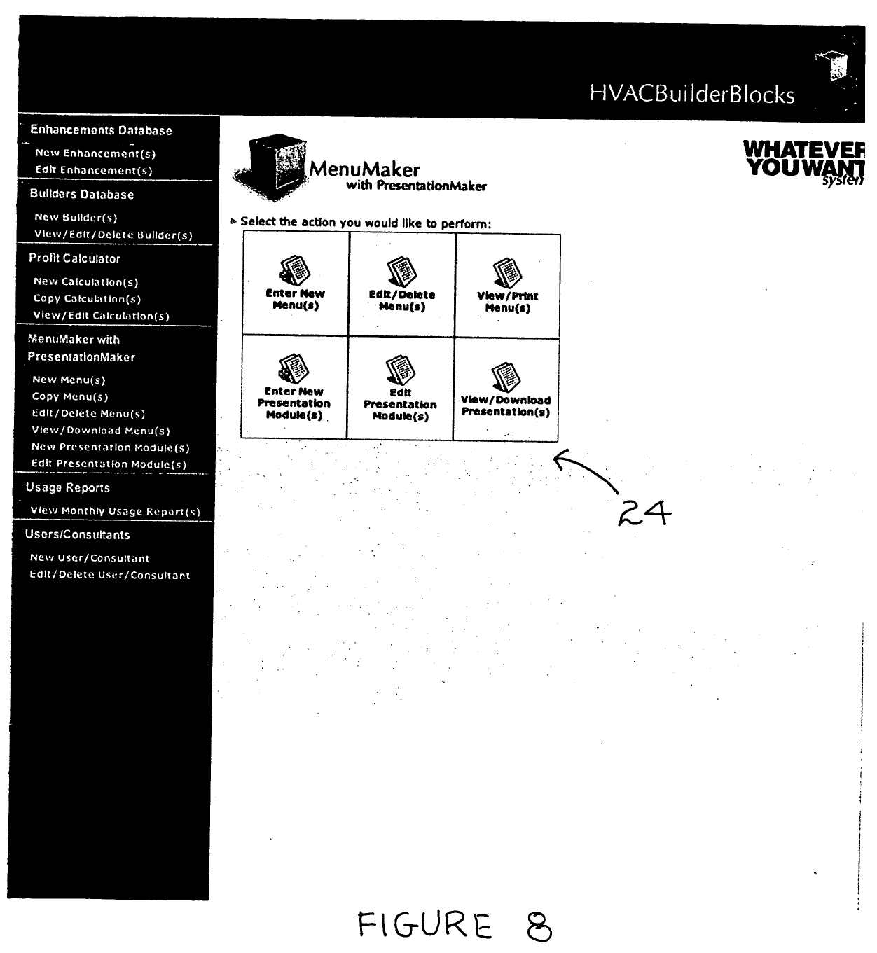

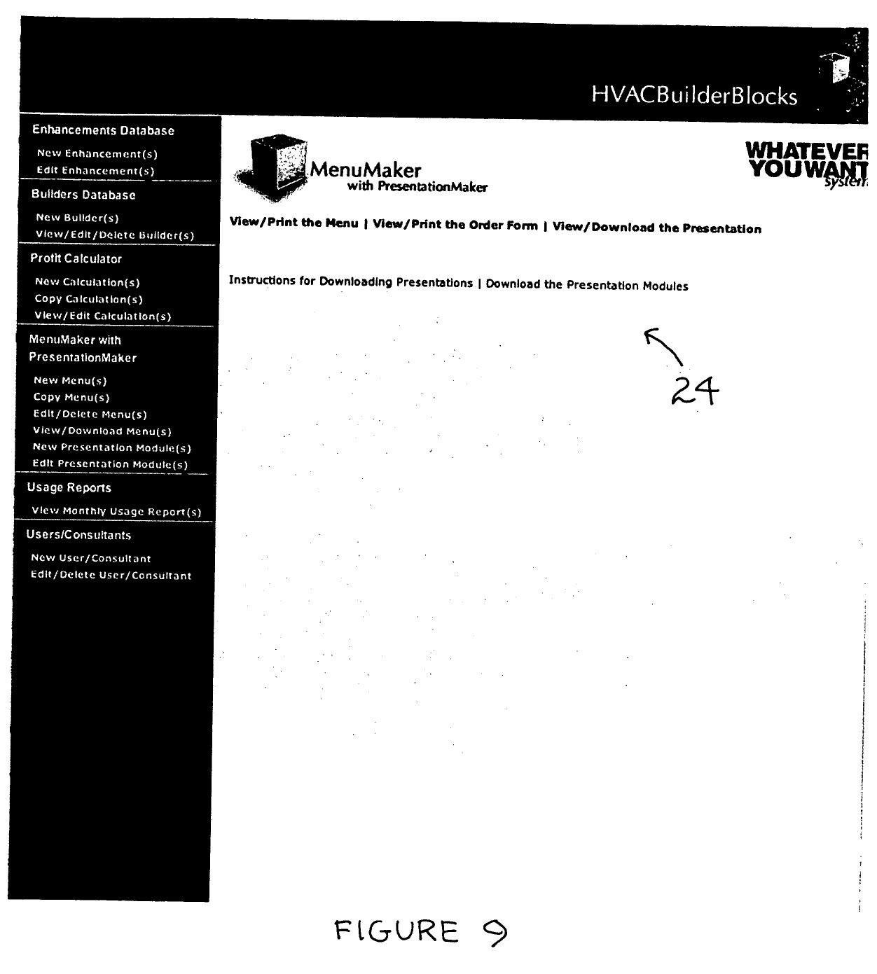

FIG. 8 shows a computer screen that can be used as part of the preferred embodiment for using 22 the information in the first, second, third and fourth databases to generate without additional user input a menu and order form of building system component options available to the customer. As shown in FIGS. 8 and 9, this step of the method 10 may also comprise editing or printing an existing menu.

Returning to FIG. 1, the method 10 further comprises using 24 the information in the first database, the second database, the third database and the fourth database to generate without additional user input at least one of a presentation or an on-line store. The step of using 24 the information in the first, second, third, and fourth databases to generate without additional user input the presentation or the on-line store may also comprise editing, downloading, viewing or printing the presentation or the on-line store. FIGS. 8 and 9 show computer screens for generating, editing viewing and downloading the presentation. The presentation may comprise information about the operation of each building system component, the applicable operating instructions, applicable warranties, recommended maintenance schedule, or parts options (such as filters, light bulbs, batteries) for each building system component The presentation may also be limited to information regarding each building system component selection. In addition, the presentation may also comprise options for having the installer perform recommended maintenance, for example, under a service agreement.

As shown in FIG. 1, the method 10 also comprises presenting 26 at least one of the menu, the order form, the presentation and the on-line store to the customer. The menu, the order form, the presentation or the on-line store may be presented to the customer electronically or by other means convenient for the customer.

Referring to FIG. 1, the method 10 also comprises having 28 the customer select from among the building component options presented on the menu. This selection represents a building system component selection. The customer may use the menu, the presentation, the order form, the on-line store or other information to help in making the building system component selection. The customer may access this information through electronic means, through a representative of the builder or installer, or through any other available means. For example, the information in the first database, the second database, the third database and the fourth database may be used without additional user input to calculate how the customer's overall mortgage amount and his monthly mortgage payment may change based on the retail price for any building system component selection. If the customer believes the building system component selection adds too much money to his monthly mortgage payment, for example, then he may change the building system component selection.

In addition, as shown in FIG. 1, the method 10 of the present invention further comprises transmitting 30 the building system component selection to the installer. Transmitting 30 the building system component selection to the installer may be accomplished by having the customer complete the order form electronically or in writing. Transmitting 30 the building system component selection may or may not be done directly to the installer. For example, an electronically-completed order may be transmitted instantaneously to the installer via the internet or other electronic means. A written order form completed by hand may be transmitted to the installer via any known means, including regular mail, electronic mail, or facsimile transmission. The written or electronically-completed order form may also be transmitted to the builder who then may transmit the form to the installer.

FIG. 1 also shows that the method 10 further comprises contacting 32 the customer about at least one of maintenance, repairs, service and enhancements for the building system component selection. In the preferred embodiment, contacting 32 the customer is accomplished via electronic mail. During the presentation, the customer may be asked if he wants to receive electronic mail notices concerning periodic maintenance, seasonal service, enhancements for the building system component selection, or any other information that might apply to the building system component. If, for example, the customer's building system component selection were a heating system, then under the preferred embodiment, he would receive electronic mail notices when it is time to change the filter or time to service the system. In other embodiments, means of contact other than electronic mail may also be used.

Referring to FIG. 1, method 10 of the present invention also comprises providing 34 a means for the customer to order materials, supplies, parts, repairs, service, enhancements or other applicable good or services for the building system component selection. Keeping with the same example as above, once the customer receives the electronic mail notice reminding him that the filter for his heating system needs to be changed, he can then order a replacement filter using the on-line store. The only information the customer would need to provide would be his electronic mail address and the request to send the replacement filter. The make and model number of the replacement filter for the customer's heating system would already have been stored in the fourth database, having been input when the customer made his building system component selection. The customer could employ other means to order the replacement filter, as well. For example, he could place his order by telephone instead of by electronic mail. The order may be placed with the installer or with any entity providing materials, supplies, parts repairs, service, enhancements or other goods or services to or for the installer. For example, the installer may sell replacement filters directly to the customer, or the installer may establish an on-line link through its on-line store to another source from whom the customer can buy the replacement filter.

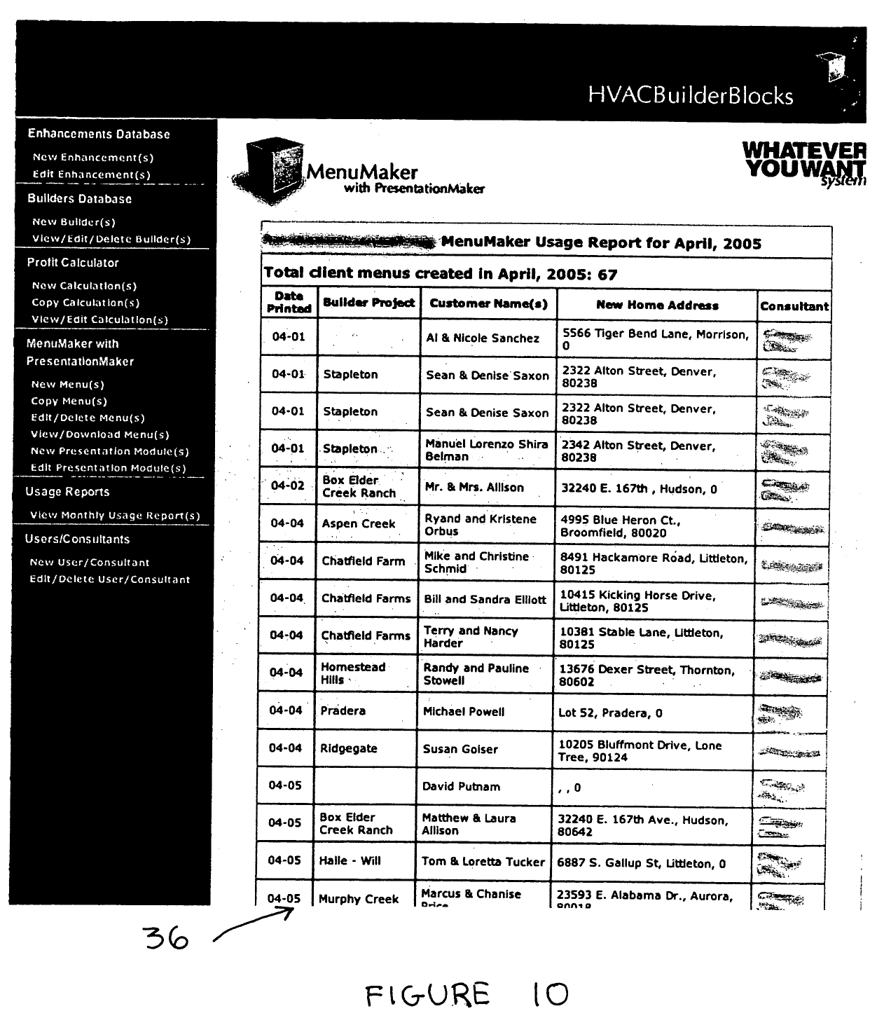

In yet another embodiment, the method 10 may further comprise tracking 36 without additional user input the presenting of the menu, the order form, the presentation or the on-line store to the customer. This can be accomplished by generating periodic reports through the database in which the menus are stored. An example of such a report is shown in FIG. 10.

In another embodiment, the information about the building system component, the customer, the builder, or cost, price or profit may be compiled or organized by any means known to one of ordinary skill in the art. In addition, the menu may also be generated by any means known to one of ordinary skill in the art.

In yet another embodiment, the presentation may be generated using the first, second and third databases without additional user input. For example, the presentation may be generated for the builder to permit the builder to decide which building system component options the builder will offer to customers for each building type. In this example, the builder may select from among the entire list of available building system component options a narrower range of building system component options that the builder may offer to its customers.

In still another embodiment, using the first, second, third and fourth databases to generate the presentation without additional user input may not take place until the customer has made the building system component selection. Once the building system component selection is input into the fourth database, the first, second, third and fourth databases may be used to generate the presentation without additional user input; however, the presentation then may be limited to information about the building system component selection, as opposed to the building system component options.

In yet another embodiment, the menu, order form, presentation or on-line store may be presented to the customer in person by a representative of the installer. During the presentation, the representative of the installer may review with the customer the operation of each building system component selection, reviewing applicable operating instructions, recommended maintenance schedule, and parts options (such as filters, light bulbs, batteries) for each building system component selection. In addition, the representative may also present to the customer options for having the installer perform recommended maintenance, for example, under a service agreement. The presentation may take place at one session or several sessions. For example, a part of the presentation may take place before the building is constructed when the representative of the installer meets with the customer to explain the building system component options so that the customer can make at least one building system component selection. Another part of the presentation may then take place after the customer has purchased the building so that the representative of the installer can instruct the customer on-site about the characteristics (such as operation, performance and maintenance) of each building system component selection. As would be familiar to one of ordinary skill in the art, the precise subjects to be covered in the presentation will depend on the nature and function of the specific building component selection. For example, the presentation of an HVAC building component selection may be more extensive than the presentation of a central vacuum building component selection. Depending on the number and type of building system component selections, a representative of each installer may be required to conduct the presentation required for the building system components installed by each installer.

In conclusion, the claimed present invention represents an important development in the field of selecting building system components. The methods according to the present invention are novel, distinctive, and highly beneficial from a utilitarian standpoint. Having herein set forth various embodiments of the present invention, it is anticipated that modifications will naturally occur to those of skill in the art after becoming familiar with the present invention. It is anticipated that such suitable modifications will nonetheless remain within the scope of the invention. The invention shall therefore be construed in accordance with the following claims.

We Claim:

1. A method for selecting a building system component, comprising,
compiling information about at least one building system component;
compiling information about at least one customer;
generating without additional user input a menu of building system component options available to said customer, said menu being based on at least said information about said building system component and said information about said at least one customer;
presenting said menu to said customer; and
having said customer select a building system component from among said building system component options on said menu, said selection comprising a building system component selection.

2. The method of claim 1 wherein said compiling information regarding said at least one building system component further comprises at least one of maintenance, operation, performance, troubleshooting, repair and price.

3. The method of claim 1 wherein said compiling information about at least one customer further comprises at least one of building type, mortgage information, and contact information.

4. The method of claim 1 wherein said information about at least one customer further comprises information allowing said customer to be contacted via electronic interface.

5. The method of claim 1 further comprising organizing said information about said at least one building system component by builder.

6. The method of claim 5 wherein said organizing said information about said at least one building system component by builder further comprises organizing said information about said at least one building system component by building type.

7. The method of claim 1 further comprising using a computer system to perform the method.

8. The method of claim 1 further comprising informing an installer of said building system component selection.

9. The method of claim 1 further comprising installing said building system component selection.

10. The method of claim 9 further comprising contacting said customer about at least one of maintenance, repairs, service and enhancements for said building system component selection.

11. The method of claim 10 wherein said contacting said customer about at least one of maintenance, repairs, service and enhancements for said building system component selection further comprises contacting said customer via electronic means.

12. The method of claim 11 further comprising providing said customer with an electronic interface for ordering at least one of materials, supplies, components, repairs and service for said building system component selection.

13. The method of claim 1 wherein said generating without additional user input said menu of building system component options available to said customer further comprises generating at least one of an order form, a presentation and an on-line store.

14. The method of claim 13 further comprising recording said building system component selection on said order form.

15. The method of claim 14 wherein said recording said building system component selection on said order form is done electronically.

16. The method of claim 15 further comprising transmitting said order form to an installer.

17. The method of claim 1 further comprising:
organizing said information about said at least one building system component by builder and building type;
informing an installer of said at least one building system component selection;
installing said at least one building system component selection; and
contacting said customer about maintaining said at least one building system component selection.

18. A system for selecting a building system component, comprising:
a means for compiling information about at least one building system component;
a means for compiling information about at least one customer;
a means for generating without additional user input a menu of building system component options available to said customer, said menu being based on at least said information about said at least one building system component and said information about said at least one customer;
a means for presenting said menu to said customer; and
a means for having said customer select at least one building system component from among said building system component options on said menu, said selection comprising a building system component selection.

19. The system of claim 18 further comprising a means for organizing said information about said at least one building system component by builder and building type.

20. The system of claim 18 further comprising a means for informing an installer of said building system component selection.

21. The system of claim 20 further comprising a means for installing said building system component selection.

22. The system of claim 21 further comprising a means for contacting said customer about at least one of maintenance, repairs, service and enhancements for said building system component selection.

23. The system of claim 22 further comprising a means for said customer to order at least one of materials, supplies, repairs, service and enhancements for said building system component selection.

24. A method for using a computer to select a building system component, comprising:
inputting information about at least one building system component in a first database;
inputting information about at least one builder in a second database;
inputting information about at least one of cost, price, and profit for said at least one building system component in a third database;
using the information in said first database, said second database and said third database to calculate without additional user input a retail price for said at least one building system component and storing said retail price in said third database;
inputting information about at least one customer in a fourth database;
using said information in said first database, said information in said second database, said information in said third database and said information in said fourth database to generate without additional user input a menu and order form of building system component options available to said at least one customer;
using said information in said first database, said information in said second database, said information in said third database, and said information in said fourth database to generate without additional user input at least one of a presentation and an on-line store;
presenting at least one of said menu, said order form, said presentation and said on-line store to said customer; and
having said customer select from among said building system component options, said selection comprising a building system component selection.

25. The method of claim 24 further comprising transmitting said building system component selection to an installer.

26. The method of claim 24 further comprising tracking said presenting of at least one of said menu, said order form, said presentation and said on-line store to said customer.

27. The method of claim 26 wherein said tracking is done without additional user input.

28. The method of claim 24 further comprising contacting said customer about at least one of maintenance, repairs, service and enhancements for said building system component selection.

29. The method of claim 28 further comprising providing a means for said customer to order at least one of materials, supplies, parts repairs, service and enhancements for said building system component selection.

30. The method of claim 24 wherein said information about said at least one customer further comprises at least one of building type, mortgage information and contact information.

31. The method of claim 30 wherein said mortgage information further comprises a mortgage amount, and further comprising using said information in said first database, said information in said second database, the information in said third database and said information in said fourth database to calculate without additional user input a change in said mortgage amount based on said retail price of said building system component selection.

32. A method for selecting a building system component, comprising:
inputting information about at least one building system component in a first database;
inputting information about at least one builder in a second database;
inputting information about at least one of cost, price and profit for said at least one building system component in a third database;
using said information in said first database, said second database and said third database to generate without additional user input a presentation of building system component options available to said at least one builder;
presenting said presentation to said at least one builder; and
having said builder select from among said building system component options.
